(19) United States
(12) Patent Application Publication
(10) Pub. No.: US 2014/0149172 A1
(43) Pub. Date: May 29, 2014

(54) SYSTEM AND METHOD FOR SUPPLY MANAGEMENT

(71) Applicant: LEAN SUPPLY SOLUTIONS INC., North York (CA)

(72) Inventors: Robert ROGUT, North York (CA); Kateryna LYASHCHENKO, North York (CA); Tomasz KRZEPKOWSKI, North York (CA)

(73) Assignee: LEAN SUPPLY SOLUTIONS INC., North York (CA)

(21) Appl. No.: 13/689,016

(22) Filed: Nov. 29, 2012

(51) Int. Cl. G06Q 10/06

(52) U.S. Cl. CPC G06Q 10/06316
USPC 705/7.26

(57) ABSTRACT

A server for managing overall supply chain and data management and a client for initiating data collection are provided as part of a system. The client can perform data collection operations on the basis of tasks, subtasks and workflows. Tasks can be based on supply chain processes. As data collection is performed, the client is updated to indicate appropriate additional operations that can be performed. Server can be used to design and maintain tasks and operations and can also be used to supply these tasks to the client. Client and server can cooperate in validation of collected data and update of overall supply chain operations accordingly. The system can also be used for carrying out operations other than data collection, such as supply tracking.

### FIELD OF INVENTION

The present invention relates generally to data collection, and more particularly to a system and method for supply chain data management.

### BACKGROUND

Various forms of processes exist for tracking of materials through stages of a supply chain. For example, warehouse data can be managed through on site scanners which track inventory as it comes in and out of the inventory. Mobile scanners allow the users to perform inventory tracking within the warehouse. As a further example, shipping companies allow tracking of their shipments through web accessible services. As different process components are adapted for computerized and network based operations, automated and mobile supply management systems, including those for the collection, processing and updating of data related to a supply chain are needed.

### SUMMARY

It is an object to provide a novel system and method for account data management and organization that obviates and mitigates at least one of the above-identified disadvantages of the prior art. An aspect of the specification provides a method of collecting supply chain information for an item on a handheld device comprising the steps of:

receiving a selection of a task, the task including subtasks linked by a workflow;

indicating a first set of subtasks to perform based on said workflow;

receiving an input indicating the performance of a selected subtask selected from the first set of subtasks; and

indicating a second set of subtasks to perform based on the workflow and the first performed subtask.

The method can further include the step of receiving the task from a server. The task can include a predetermined criteria and the performance of the task can be repeated until the predetermined criteria is met. The predetermined criteria can be a number of items to be identified.

The selected subtask can include one of a barcode scan, an RFID tag scan, an image capture, an audio capture, a video capture and a text entry. The input can be determined to be invalid, and the method can further include the step of providing an instruction on how to perform the selected subtask.

The task can be based on a supply chain process. The supply chain process can be one of receiving, shipping, transfer or put-away.

The method can further comprise the step of indicating performance of the selected subtask with an input indicator. The selected subtask can be a data scan operation and the input indicator can be a text representation the scanned data.

The method can further comprise the steps of:

presenting a graphical representation of a physical object containing at least a part of the supply chain information for the item; and

indicating, on said graphical representation, each of said first and second set of subtasks that are to be performed.

The method can further include the step of indicating a set of tasks, and the presentation can be based on a logged-in account status indicator. The logged-in account status indicator can include one of operator, manager, and 3rd party.

The method can further include the steps of providing a map and indicating a location for each of the first and second set of subtasks. The indication of each subtask in the first and said second set of subtasks can be in part based on a location of the handheld device.

The method can further comprise the steps of:

providing an image of the area proximal to the handheld device; and

indicating locations for the first and second set of subtasks on said image. The performance of at least one of the subtasks indicated can be mandatory. The indication of the first and second subset of subtasks can be arranged in order of priority.

In another aspect, a handheld device including a processor for collecting supply chain information for an item is provided. The handheld device comprises:

at least one input device connected to the processor for receiving a selection of a task, the task including subtasks linked by a workflow;

an output device connected to the processor for indicating a first set of subtasks to perform based on said workflow;

the at least one input device further receiving an input indicating the performance of a selected subtask selected from the first set of subtasks; and

the output device further indicating a second set of subtasks to perform based on the workflow and the first performed subtask.

The handheld device can further comprise the at least one output device presenting a graphical representation of a physical object containing at least a part of the supply chain information for the item, the graphical representation including an indication of each of the first and second set of subtasks that are to be performed.

### BRIEF DESCRIPTION OF DRAWINGS

FIG. 1 shows a block diagram of an embodiment of a system for data collection and management;

FIG. 2 shows a block diagram of another embodiment of a system for data collection and management;

FIG. 3 shows a flow chart showing a method of data collection and management in accordance with an embodiment;

FIG. 4 shows a shows a diagram of a client in accordance with an embodiment;

FIG. 5 shows a shows a diagram of a client in accordance with an embodiment;

FIG. 6 shows a shows a diagram of a client in accordance with an embodiment;

FIG. 7 shows a diagram of a client in accordance with an embodiment;

FIG. 8 shows a diagram of a client in accordance with an embodiment;

FIG. 9 shows a diagram of a client in accordance with an embodiment; and

FIG. 10 shows a diagram of a client in accordance with an embodiment.

### DETAILED DESCRIPTION

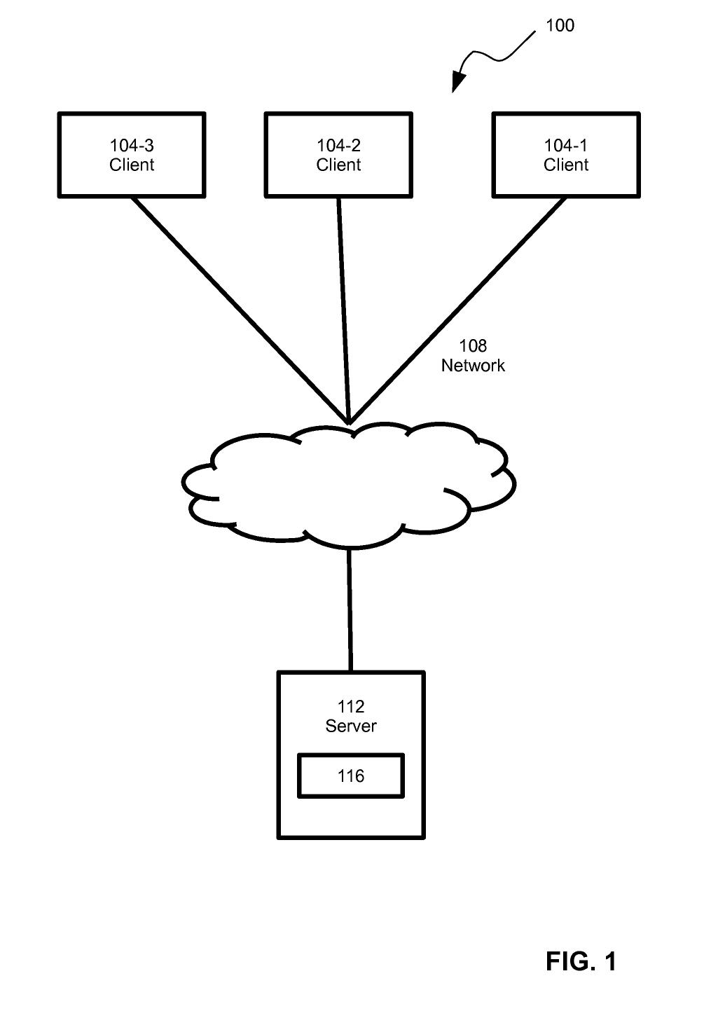

FIG. 1 shows a diagram of a system 100 for supply chain management. At least one client terminal (client terminals 104-1, 104-2 and 104-3) is connected, via network 108, to server 112. Collectively, client terminals 104-1, 104-2 and 104-3 are referred to as client terminals 104, and generically as client terminal 104. This nomenclature is used elsewhere herein.

Client terminals 104 can be based on any suitable handheld computing environment, and the type is not particularly limited so long as each client terminal 104 is capable of receiving data from server 112, displaying data in graphical form and transmitting data to server 112. In a present embodiment, client terminals 104 are configured to at least execute a client application or a browser that can interact with the web service hosted by server 112.

Client terminals 104 can be based on any type of handheld client computing environment, such as a tablet, a smart phone, a PDA, other mobile computing device or any other handheld platform suitable for graphical display that is known in the art. Each client terminal 104 includes at least one processor connected to a non-transitory computer readable storage medium such as a memory. Memory can be any suitable combination of volatile (e.g. Random Access Memory (“RAM”)) and non-volatile (e.g. read only memory (“ROM”), Electrically Erasable Programmable Read Only Memory (“EEPROM”), flash memory, magnetic computer storage device, or optical disc) memory. In one embodiment, memory includes both a non-volatile memory for persistent storage computer-readable instructions and other data, and a volatile memory for short-term storage of such computer-readable instructions and other data during the execution of the computer-readable instructions. Other types of computer readable storage medium external to client terminal 104 are also contemplated, such as secure digital (SD) cards and variants thereof. Other examples of external computer readable storage media include compact discs (CD-ROM, CD-RW) and digital video discs (DVD).

Client terminal 104 can also include one or more input devices connected to at least one processor. Such input devices are configured to receive input and provide data representative of such input to the processor. Input devices can include, for example, a keypad, a pointing device and a scanner. A pointing device can be implemented as a computer mouse, track ball, track wheel, touchscreen or any suitable combination thereof. A scanner can be an image scanner, or a bar code scanner, as well as an NFC scanner such as an RFID tag scanner. In some examples, client terminal 104 can include additional input devices in the form of one or more additional buttons, sensors, microphones and the like. More generally, any suitable combination of the above-mentioned input devices can be incorporated into client terminal 104. The input devices can be integral to a device or can be an add-on option which can be operably connected to the device as needed.

Client terminal 104 further includes one or more output devices. The output devices of client terminal 104 can include a display. When the pointing device includes a touchscreen, the touchscreen can be integrated with the display. Each client terminal can also include additional output devices such as printers. The output devices can be integral to a device or can be an add-on option which can be operably connected to the device as needed.

Each client terminal 104 also includes one or more communications interface connected to the processor. The communications interface allows client terminal 104 to communicate with other computing devices, for example via network 108, as well as peripherals such as headsets, handheld scanners, and other input and output devices that will now occur to a person of skill in the art. At least one of the communications interfaces can be selected for compatibility with network 108. The communication interfaces may be wireless radios such as Bluetooth, cellular radio such as LTE, near field communications (NFC) or Wi-Fi, or they may be wired such as USB, serial or parallel ports.

Network 108 can comprise any network capable of linking server 112 with client terminals 104 and can include any suitable combination of wired and/or wireless networks, including but not limited to a Wide Area Network (WAN) such as the Internet, a Local Area Network (LAN), Personal Area Network (PAN), cell phone networks, Wi-Fi networks, and the like.

In general terms, server 112 can comprise any platform capable of processing, transmitting, receiving, and storing data. In a present embodiment, server 112 is a server configured for database management and data processing as well as web-service provision. Server 112 can be based on any desired server-type computing environment including appropriate configurations of one or more central processing units (CPUs) configured to control and interact with non-transitory computer readable media in the form of computer memory or a storage device. Computer memory or storage device can include volatile memory such as Random Access Memory (RAM), and non-volatile memory such as hard disk drives or FLASH drives, or a Redundant Array of Inexpensive Disks (RAID) or cloud-based storage. Server 112 also includes one or more network interfaces, to connect to network 108 or client terminal 104. Server 112 can also be configured to include input devices such as a keyboard or pointing device or output devices such as a monitor or a display or any of or all of them, to permit local interaction. Other types of hardware configurations for server 112 are contemplated. For example, server 112 can also be implemented as part of a cloud-based computing solution, whereby the functionality of server 112 is implemented as one or more virtual machines executing at a single data center or in a mirrored form across a plurality of data centers. The software aspect of the computing environment of server 112 can also include remote access capabilities in lieu of, or in addition to, any local input devices or local output devices. Any desired or suitable operating system can be used in the computing environment of server 112. The computing environment can be accordingly configured with appropriate operating systems and applications to effect the functionality discussed herein. Those of skill in the art will now recognize that server 112 need not necessarily be implemented as a stand-alone device and can be integrated as part of a multi-purpose server or implemented entirely in software, for example a virtual machine. In a present embodiment, server 112 is connected to a storage device 116, such as a hard-disk drive, solid state drive, or any other type and arrangement of non-volatile storage device. In other embodiments, storage device 116 can be integral with server 112.

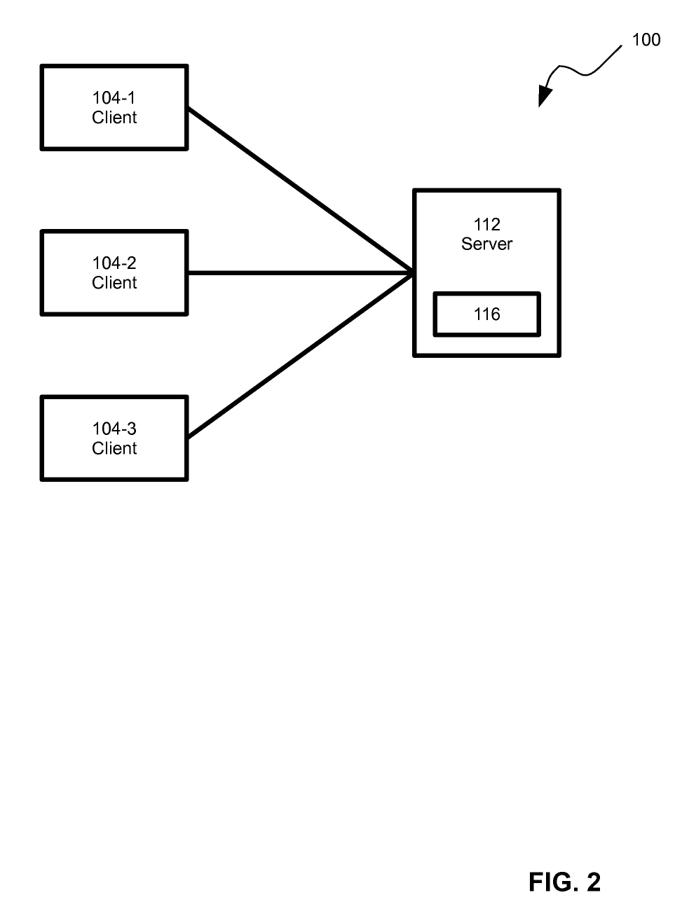

In another embodiment of system 100, as shown in FIG. 2, client terminals 104 may connect directly, either through wires or wireless to server 112.

Variations in the implementation of system 100 will now occur to one of skill in the art, all of which are contemplated as possible implementations of system 100 and are considered within scope. For example, each client terminal 104 can be connected directly to storage device 116, accessing and operating upon the contents of the storage device 116 directly, without an intermediary server 112.

In an embodiment, server 112 is operable to design and manage processes and workflows necessary for supply chain and warehouse management. In one example, server 112 can be accessed remotely through one of client terminals 104, for example, to design or execute a process. The processes and workflows may be associated with supply chain tasks.

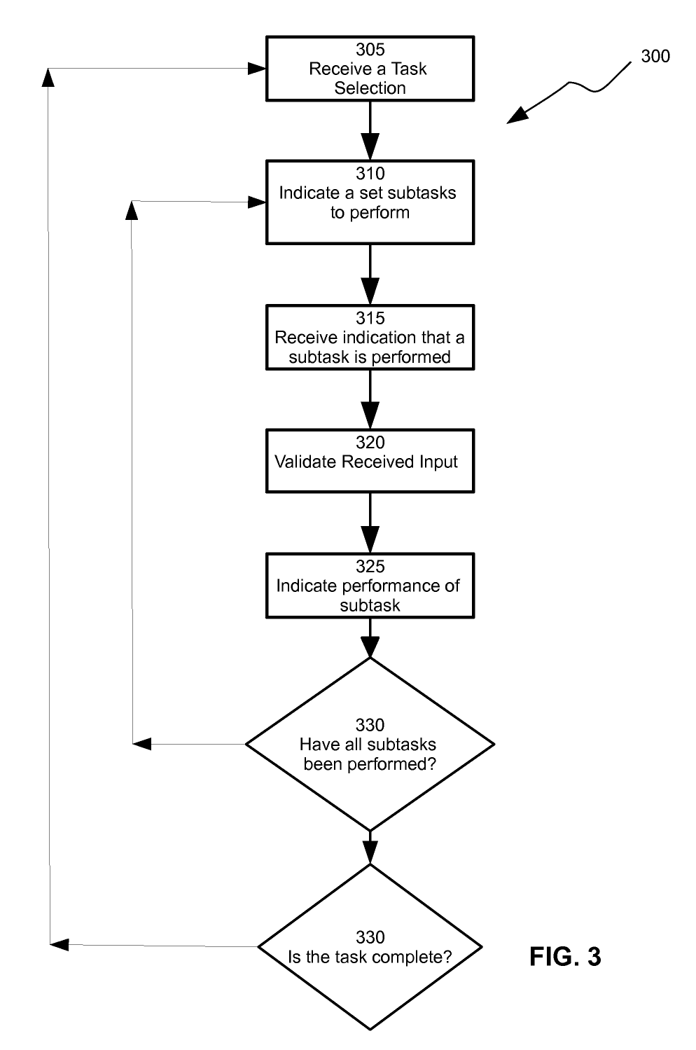

Referring now to FIG. 3, a method of performing supply chain operations is indicated generally at 300. In order to assist in the explanation of the method, it'll be assumed that method 300 is operated using system 100 as shown in FIG. 1, Additionally, the following discussion of method 300 leads to further understanding of system 100. However, it is to be understood that system 100, and method 300 can be varied, and need not work exactly as discussed herein in conjunction with each other, and that such variations are within scope.

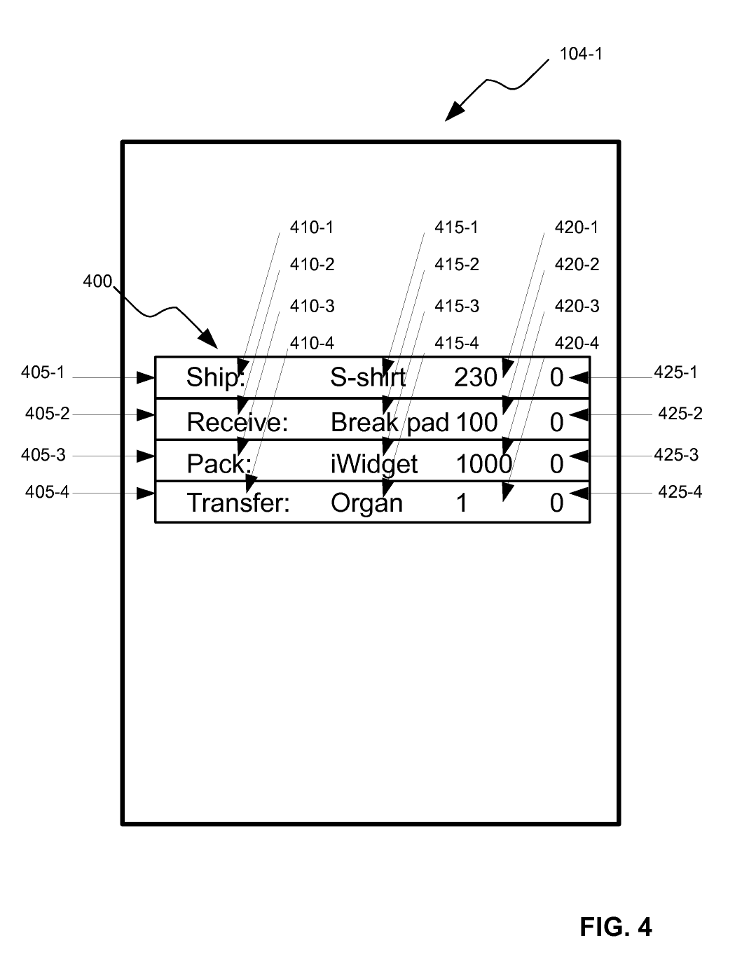

Referring back to FIG. 3, a selection of a supply chain task is received at 305. In the present example, and as shown in FIG. 4, a task list 400 is presented on the display of a client terminal 104. Task list 400 contains tasks 405-1, 405-2, 405-3, and 405-4. Collectively, tasks 405-1, 405-2, 405-3 and 405-4 are referred to as tasks 405, and generically as task 405. This nomenclature is used elsewhere herein. It is to be understood that task list 400 is merely an example way of presenting a number of available tasks, and that available tasks can be presented in other manners as discussed further below.

A supply chain task 405 is based on a supply-chain process, and is performed on one or more items. Referring back to example embodiment shown in FIG. 4, each task 405 includes a process 410 identifying the process type the task is based on. In the present example, specifically 410-1, 410-2, 410-3 and 410-4 are shown. Collectively, processes 410-1, 410-2, 410-3 and 410-4 are referred to as processes 410, and generically as process 410. In the present example embodiment, the processes shown are shipping, 410-1, receiving, 410-2, packing, 410-3 and transferring to another location, 410-4. In a variation, only tasks that are available at a current location of client terminal 104, determined on the basis of location based services, can be shown. In other variations a task 405 can include more than one process. In further variations, tasks 405 can comprise processes 410 different than those included in this example embodiment such as putting away, ordering, loading or others, alone or in combination, that will now occur to a person of skill in the art.

Continuing with FIG. 4, each task 405 also includes an item 415 which will be involved in the performance of the corresponding process or processes. In the present example, specifically 415-1, 415-2, 415-3 and 415-4 are shown. Collectively, items 415-1, 415-2, 415-3 and 415-4 are referred to as items 415, and generically as item 415. In the present example embodiment, the items shown are S-shirt, 410-1, break-pad, 410-2, iWidget, 410-3 and organ for transplant, 410-4. In variations, a task 405 can include more than one item 415. In other variations, the item to be processed can be any item that can be involved in a supply chain operation such as whole items or parts of items. In other variations, items can be composed of mechanical, chemical or biological materials including cells, organs and animals and items can be contained in other entities such as trucks, containers, pellets, boxes or envelopes of items. In yet further variations, a task 405 can comprise processing combination of different items. Other variations will now occur to a person of skill in the art.

Continuing with FIG. 4, each task 405 also includes a quantity demanded 420 of associated item 415. In the present example, specifically 420-1, 420-2, 420-3 and 420-4 are shown. Collectively, quantity demanded 420-1, 420-2, 420-3 and 420-4 are referred to as quantities demand 420, and generically as quantity demanded 420. The quantities demanded shown are 230 of S-shirt 410-1, 100 of break-pads 410-2, 1000 of iWidget 410-3 and 1 of organ for transplant 410-4. It is to be understood that in other variations, the number of items to be processed can be any number, and accordingly, quantities demanded 420 are not limited to the illustrative examples of FIG. 4.

Continuing with FIG. 4, each task 405 also includes a quantity completed 425 of associated item 415. In the present example, specifically 425-1, 425-2, 425-3 and 425-4 are shown. Collectively, quantity completed 425-1, 425-2, 425-3 and 425-4 are referred to as quantities completed 425, and generically as quantity completed 425. In the present example embodiment, the quantities completed shown are all 0. It is to be understood that in other variations, the number of items for which the performance of a process 410 has been completed can be any number, and is not limited to the illustrative examples of FIG. 4.

In the present example embodiment, it'll be assumed that the task 405-1, shipping 230 S-shirts, of which none has yet been shipped, is selected for performance. It is to be understood that the task of shipping 230 S-shirts has been chosen for illustrative purposes and other supply chain tasks can be performed using method 300 and system 100 as it will now occur to a person of skill in the art.

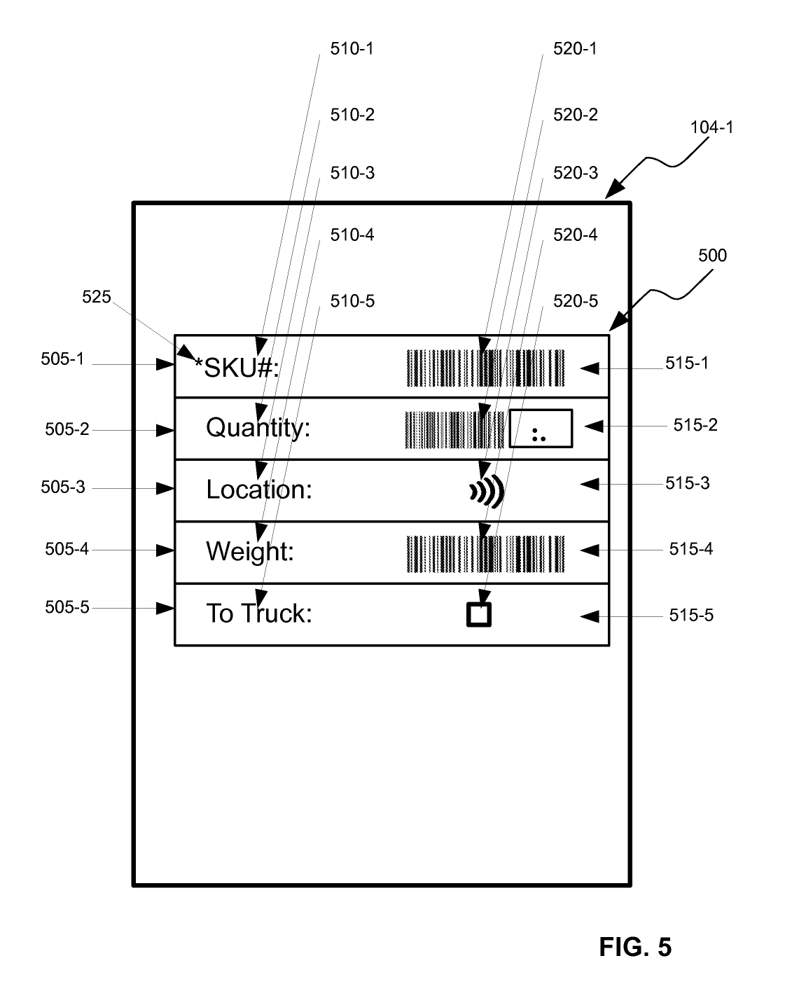

Referring back to FIG. 3, and continuing with Method 300, subtasks are indicated at 310. The subtasks indicated can be on the basis of the selected task, for example, task 405-1 in the present example embodiment, and can correspond to subtasks to perform to perform at least part of the process 410 associated with the task 405, in the present example embodiment shipping 410-1. In the present example, and as shown in FIG. 5, a list 500 is presented on the display of a client terminal 104. List 500 contains subtasks 505-1, 505-2, 505-3, 505-4 and 505-5. Collectively, subtasks 505-1, 505-2, 505-3, 505-4 and 505-5 are referred to as subtasks 505, and generically as subtask 505. This nomenclature is used elsewhere herein.

A subtask 505 can involve performing an operation 510 that is an element of the performance of a task 405. For example, as shown in FIG. 5, Subtask 505-1 indicates that S-shirts SKU# information is to be collected. Performing all or some of subtasks 505 that are based on a task 405 can identify the items involved in that task 405, and can lead to the performance of at least part of the processes associated with that task 405. In the present example embodiment, performing the subtasks 505 shown in FIG. 5 would lead to the identification of the items to be shipped as part of task 405-1 as well as their loading to a truck.

Continuing with the example embodiment shown in FIG. 5, each subtask 505 includes an operation 510. In the present example, specifically 510-1, 510-2, 510-3, 510-4 and 510-5. Collectively, operations 510-1, 510-2, 510-3, 510-4 and 510-5 are referred to as operations 510, and generically as operation 510. An operation 510 indicates the operation that needs to be performed for the associated subtask. In the present example embodiment, the operations shown are identifying SKU#, 510-1, identifying a quantity, 510-2, identifying a location, 510-3, identifying a shipping weight, 510-4 and moving item to truck, 510-5. In variations, a subtask 505 can include more than one operation such as scan SKU# and take picture of the item. In further variations, subtasks 505 can comprise operations 510 that are different than those included in this example embodiment such as identifying a container or truck number or other information. In other variations, subtask 505 can involve performing operations other than collecting information such as physically moving an item from which information was scanned. Other operations will now occur to a person of skill in the art that when performed can identify items and carry out the process on which a task 405 is based.

Continuing with the example embodiment and referring back to FIG. 5, each subtask 505 further includes an input value 515 specifically 515-1, 515-2, 515-3, 515-4 and 515-5. Collectively, input values 515-1, 515-2, 515-3, 515-4 and 515-5 are referred to as input values 515, and generically as input value 515. This nomenclature is used elsewhere herein. Initially, an input value 515 can indicate the type of input that is expected as a result of performing the associated operation 510. In the present example embodiment, the input values shown in FIG. 5 include indicators 520 for a barcode, 520-1 and 520-4, a barcode and keyboard, 520-2, an RFID tag 520-3, and a checkbox, 520-5. Accordingly, input value 515-1 which includes a bar code indicator 520-1, indicates a bar code input is expected. Thus, input value 515, particularly in the case of information collection operations, can also indicate the type of operation to perform. For example, input value 510-2, which includes a barcode and keyboard indicator 520-2, indicates that the associated input operation of obtaining a barcode, 510-2, can be performed either by a barcode scan or a keyboard entry. It will now occur to a person of skill in the art that the indicators 520 shown for input values 515 are examples, and other types of indicators are possible. For example, indicators can be graphical, color coded, text based or a combination. Alternatively, input values 515 may simply be empty text boxes, or can be left blank and thus include no indicators. These and other variations are within scope.

Continuing with the example embodiment of FIG. 5, subtask 505-1 is marked with a mark 525, in this example an asterisk, indicating that this subtask should be performed first. In a variation, a mark 525 can indicate that the performance of the marked subtask 505 is mandatory, and that no subtasks 505 other than the marked one can be performed. In this variation, trying to perform a subtask 505 other than the indicated subtask 505 will result in error messages presented on client terminal 104 in a visual, audial or tactile manner, or a combination thereof. In variations, subtasks 505 can be presented with other indicators of preferred order or priority of performance. For example, a subtask 505 or subtasks 505 (namely a set of subtasks 505 containing one or more subtasks 505) to be performed first can be presented first in a list of subtasks. The set of subtasks 505 comprising one or more subtasks 505 to be performed next can be presented next in the list, and so on and so forth. Alternatively, subtasks 505 can be presented in no particular order, but a preferred order or priority of can be indicated through numbering, or other visual indicators, such as grouping or colored highlights or a combination of indicators. In further variations, only the set of subtasks to be performed first can be presented. Yet in further variations, performance of a subtask can alter the preferred order and composition of the sets of subtasks 505. In an additional variation, only subtasks 505 that are available at a current location of client terminal 104, determined on the basis of location based services, can be shown. Other variations will now occur to a person of skill in the art.

The priority or order of performance of subtasks can be determined on the basis of a workflow that can accompany the selected task 405. The workflow can be implemented as any data structure that allows the indication of priority or order of completion of each step or sets of steps and can be stored as part of a task 405 or separately as a file, database record, table element and other alternatives that will now occur to a person of skill in the art. Such a workflow can be created at the time the task is created, or alternatively may be created on the basis of a template to be used for similar types of tasks. For example, the templates and workflows can be created based on type of supply chain process or processes a task 405 will involve such as shipping or receiving, the type of item involved such as shirts or human organs, type of customer or the specific customer, or a combination of these and other factors which will now occur to a person of skill in the art. Workflows can also be linked to form a chain of related tasks to complete more complex supply chain processes. Templates and workflows can also be created on the basis of business processes. Workflows can be created at client 104 or server 112 or other computing devices, and integrated into system 100 to be used, reused and associated with tasks 405 as appropriate.

Continuing with the present example embodiment and referring to FIG. 5, it'll be assumed that subtask 505-1, locating a box of S-shirts and scanning the SKU# off a box is selected for performing, as indicated by mark 525.

Referring back to FIG. 3, and continuing with method 300, at 315 an indication of the performance of a selected subtask 505 is received in the form of an input. In variations, a received input can be received through manual operations, such as by text entry through a keyboard once the item containing the SKU# is identified. In other variations, manual input entry can be received from a touch screen, such as writing or signing with a stylus or a finger, and others that will now occur to a person of skill in the art. In further variations, a received input can be received in an automated fashion from the operation of an input device that facilitates automated input entry such as a bar code scanner. The input device may be integrated with client terminal 104, or may be separate from client terminal 104 and in communications with client terminal 104 through a wireless or wired connection. The wireless connection can be direct such as Bluetooth connection between a handheld barcode scanner and client terminal 104, or it may be through a network 108. In yet other variations, the input device can be an RFID tag scanner, a camera, a laser scanner, and other input devices that will now occur to a person of skill in the art.

In some variations, such as where the operation 510 does not involve information gathering, a binary input may suffice to indicate performance of an operation 510. For example, in the present example the performance of the operation of moving box to a truck, 510-5, the associated input value 515-5, which is a checkbox, can be manually manipulated to indicate the performance of the operation. It will now occur to a person of skill in the art that there are other methods of indicating performance of an operation other than through the use of a check box, such as through radio buttons, and through crossing out the entire subtask 505. In yet other variations, an identifier associated with a particular location of equipment such as a truck or a container can be scanned to indicate the performance of an operation such as moving an item to a truck. These and other such variations are within scope.

In yet other variations, operations 510 can involve output operations. Output operations can be done to help tag any items, locations, etc. involved with an operation 510 with additional information that can be based on the performance of the operation 510 or other information. For example, a label can be printed be client terminal 104 at an output device such as a bar code printer or a laser printer. Printed labels can be based on information obtained from system 100, such as server 112, or information local to client terminal 104. The output device may be integrated with client terminal 104, or may be separate from client terminal 104 and in communications with client terminal 104 through a wireless or wired connection. The wireless connection can be direct such as Bluetooth connection between a handheld barcode scanner and client terminal 104, or it may be through a network 108. Other output operations and corresponding devices will now occur to a person of skill in the art and are within scope.

Continuing with method 300 and once again referring to FIG. 3, once a subtask is performed, at 320 the received input is validated. In the example embodiment, once an SKU# is scanned, the received input is validated as being associated with items S-shirt. If the received input is determined to be invalid such as a wrong SKU# is scanned or the scanning operation does not yield a recognizable SKU#, this can be indicated. In one variation, the problem input is identified by highlighting the subtask 505 just performed, for example in red, or otherwise marking the subtask with an “x” or other indicator that provides indication that the performed input operation was problematic. The indicator can be audio or tactile, such as vibration, as well as visual, or a combination thereof. In other variations, additional information may be provided by client terminal 104 to indicate the nature of the problem, such as providing text indicating that the received input is inappropriate, or that the operation 510 could not be satisfactorily performed to result in a proper received input (for example, part of the bar code was blocked). In yet further variations additional output may be provided, based on the error, through client terminal 104 to instruct on how to properly perform the operation 510. For example, a graphic, textual or audio description can be presented indicating how to properly aim an input device to obtain a proper scan. Alternatively, a picture of the item or the barcode to be scanned may be indicated to help the operator of client terminal 104 identify the item or the barcode, if the wrong item or the barcode was scanned. Other variations will now occur to a person of skill in the art, which are within scope. For example, validation can also be used to validate location. If, during a transfer location, for example, an item, such as an organ for transplant may need to be stored or quarantined in a particular location. Accordingly, the received input associated with location can be validated to ensure the item's proper placement. In other variations, additional subtasks can also be received for performance upon validation of a subtask. For example, once a location is validated, additional subtasks may need to be performed to confirm the location's current suitability such as identifying location temperature and humidity. These additional subtasks may be pushed to client terminal 104 by server 112, or may be requested by client terminal 104. Additional subtasks may also be required to be performed as a result of real-time changes to workflows associated with a task 104, while a task 104 is being performed.

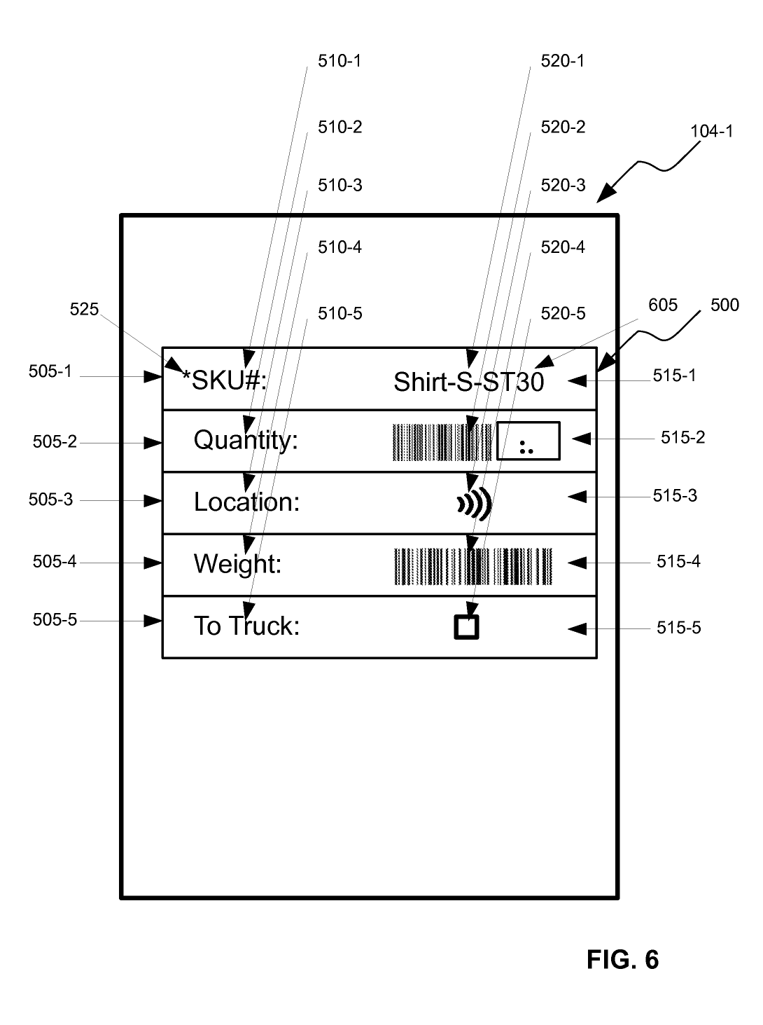

Continuing with FIG. 3, at 325 once the received input is validated, performance of the subtask is indicated. In the present example embodiment, and as shown in FIG. 6, to indicate the performance of subtask 505-1, the input value 515-1 is updated with input indicator 605 in accordance with the received input to indicate completion of the performance of subtask 505-1. As shown in FIG. 6, indicator 605 can corresponds to the content of the received input. For example, in the present example, and as shown in FIG. 6, the input indicator 605 is a textual representation of the received input. In variations, an input indicator 605 can be used to simply to indicate performance of an operation 510, and not provide any indication as to the actual content of the received input, such as by showing a check mark as input indicator 605. In other variations, other indicators of completion may be used alone or in combination. For example, a performed subtask 505 may be grayed out or marked with a graphic, text or color, in addition or in place of updating the associated input value 515. A performed sub-task 505 can also be frozen to prevent re-performance of the same subtask 505.

In some variations, the received input may be used to determine an input value 515 for subtasks 505 other than the subtask 505 that is associated with the performed operation 510. For example, received input indicating the performance of subtask 505-1 can result in determination, based on a database maintained in system 100, of an appropriate input for input value 515-3 associated with location. This determination, for example, can be done where the location of the SKU# identified by the received input can be determined, based on the database used. In further variations, the determination of which additional inputs for which subtasks 505 can be entered on the basis of a received input can be made, at least in part, on the basis of a task workflow. In other variations the determination can be made on the basis of databases stored on a client terminal 104 or can be made after further communications with server 112 to obtain additional data, or can be made by server 112, and the results of the determination can be optionally communicated back to client terminal 104. In yet further variations, the actual input value 515 for additional subtasks 505 determined on the basis of a received input for another subtask 515 may not be presented at client terminal 104, and instead those additional subtasks 515 may be indicated as not needing to be performed by, for example, graying out, or deleting from the screen.

Continuing with FIG. 3, at 330, a determination is made as to whether all the subtasks 505 composing task 405-1 have been performed. In the present example embodiment, this determination is negative since there remain subtasks 505-2 through 505-5 that have not been performed. Accordingly, method 300 returns to 310. In variations, not all subtasks 505 composing a task 405 would need to be completed for a task 405 to be considered to be complete. For example, in some variations subtask 505-4, identifying weight might not need to be determined, and thus method 300 can advance to 335 despite that subtask not being performed. The determination of which subtasks 505 are necessary for a task 405 to be complete can be made, at least in part, based on a workflow associated with a task 405.

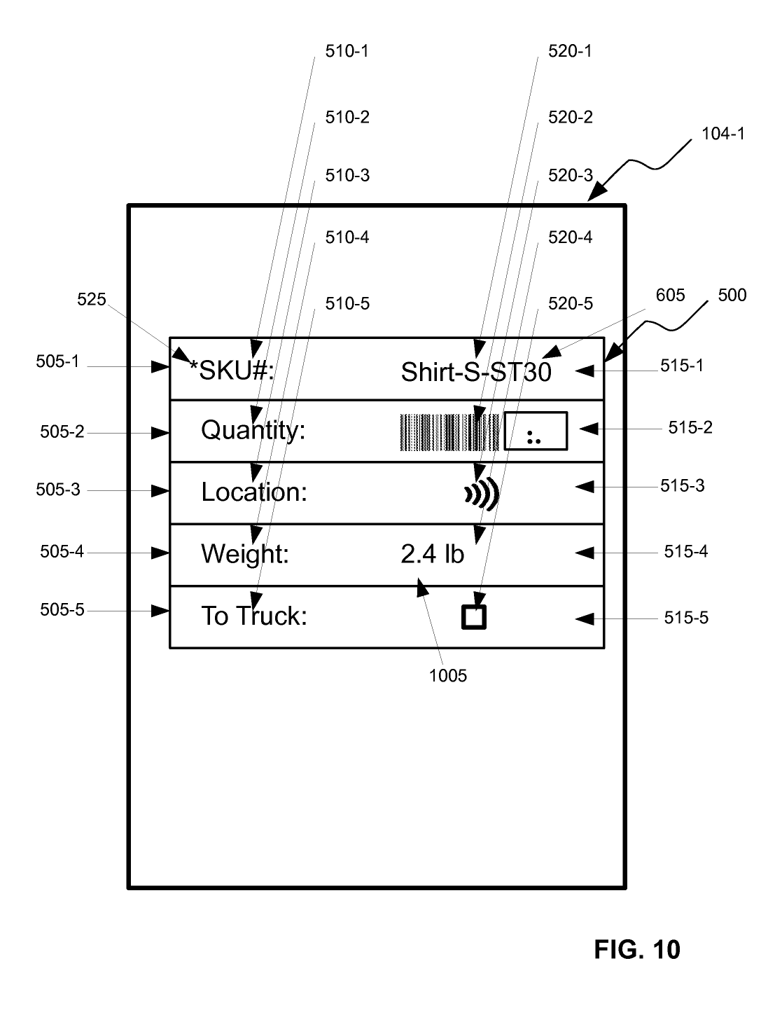

Continuing with method 300, at 310 an updated set of tasks to perform is indicated. In the present example embodiment, it is assumed that subtask 505-2 identifying a quantity and subtask 505-4 identifying a weight are both indicated. Continuing with the present example embodiment it is assumed that subtask 505-4, identifying a weight, is selected for performing. Continuing with method 300, at 315 an indication of the performance of a selected subtask is received, which in this case is received as a result of performing a barcode scan. Continuing with method 300 and once again referring to FIG. 3, once a subtask is performed, at 320 the received input is validated. In this example embodiment received weight is validated as being associated with a S-shirt. At 325 once the received input is validated, performance of the subtask is indicated. In the present example embodiment, and as shown in FIG. 10, to indicate the performance of subtask 505-4, the input value 515-4 is updated with an input indicator 1005 in accordance with the received input to indicate completion of the performance of subtask 505-4. Continuing with FIG. 3, at 330, a determination is made as to whether all of the subtasks 505 composing task 405-1 have been performed. In the present example embodiment, this determination is negative since there remain subtasks 505-2, 505-3 and 505-5 that have not been performed. Accordingly, method 300 returns to 310.

In the present example, it is now assumed that the remaining subtasks 505 composing task 405-1 are successfully performed, and method 300 advances to 335 where a determination is made as to whether the task 405-1 is complete. The determination of task completion can be based on predetermined criteria that accompany a task 405 or the workflow associated with the task. In the present example, the determination is based on the total number of shirts to be shipped which is identified as 230. Accordingly, the determination will be no, since it is assumed that only 100 shirts have been identified. Accordingly, method 300 returns to 305, and the subtasks of task 405-1 are re-performed on additional items. After two more performances of method 300, task 405-1 is determined to be completed.

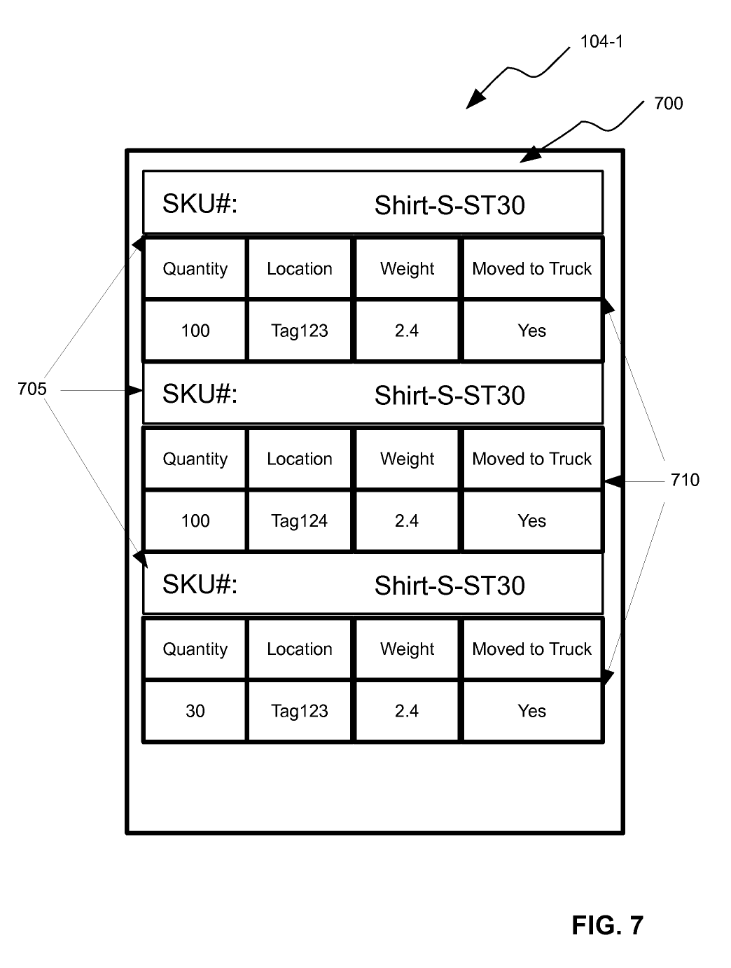

In a variation, at the completion of each iteration of task 405-1, a screen as shown in FIG. 7 may be presented on the display of client terminal 104. List 700 indicates each performance or iteration of subtasks 505 composing task 405-1. Each task iteration 705 includes a summary 710 of the result of completing subtasks 505 after performing method 300 to 330. Accordingly, task iteration 705-1 indicates the first iteration of method 300 to 330, where 100 S-shirts were identified, 705-2 indicates the second iteration of method 300 to 330, where 100 more S-shirts were identified, and task iteration 705-3 indicates the third iteration of method 300 to 330, where 30 more S-shirts were identified and method 300 was completed. In a variation each iteration 705 is done successively. In another variation, each iteration 705 can be done different times, the time gaps optionally including performance of other tasks 405 or other processes. In a further variation, an iteration 705 can be deleted if for example, identified S-shirts were later found to be damaged.

In variations, the information collected as part of each task iteration 705 or each task 405-1 can be communicated to server 112. Communication status can be indicated on client terminal 104 as, for example, pending, incomplete, complete and failed. In further variations, the information collected can be used by system 100 to update supply chain related information in general and accordingly, to assist with the overall management of the supply chain. For example, the information collected can be used to confirm that a particular supply chain process has been appropriately completed, as well as to update related supply chain information such as quantity left in the warehouse and to initiate processes for ordering additional items or informing other parties next in the supply chain that the requested items have been identified in the warehouse. These and other variations which will now occur to a person of skill in the art are within scope.

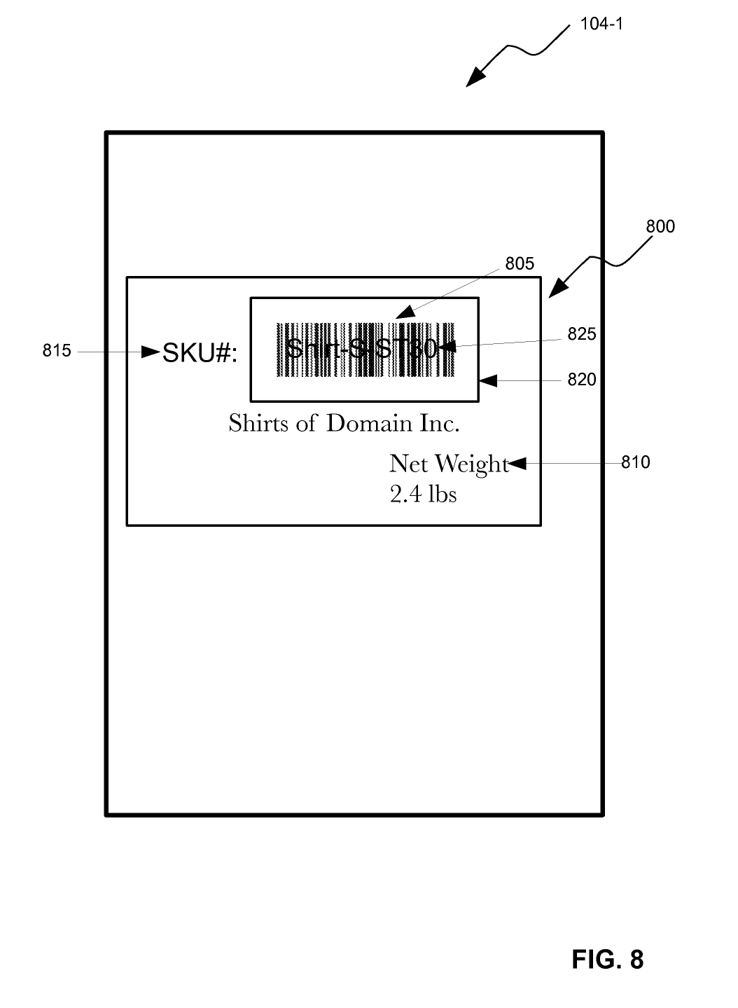

In further variations, subtasks 505 can be presented on client terminal 104 in a form other than a list 500. For example, some or all of the subtasks 505 can be indicated as part of a graphic 800. The graphic can be a representation of a physical object such as a label or portion thereof, an item or a portion thereof or a location that includes information that will be collected as part of performing those subtasks 505 indicated on the graphic. The graphic can be a photo image, a drawing or an outline or other graphical representation of a physical object that will now occur to a person of skill in the art. In a variation, each subtask 505 can be indicated within a vicinity of the graphic representation of the information to be collected for that subtask 505. For example, and as shown in FIG. 8, an item may contain a label that includes a barcode for an SKU#805, and a text showing the weight 810. In this example, the operation 510-1 of subtask 505-1 for identifying the SKU# can be indicated by placing the text “SKU#” 815 near the graphical representation of the SKU# barcode 805. Further, in the same example, expected input-value 515 can be indicated a by drawing a box 820 around the graphical representation of the SKU# barcode 805. The graphical representation of the SKU# barcode 805 can serve as indicator 520-1. When the physical barcode is scanned, the input-value box around the graphical representation of SKU# barcode can be updated to indicate the received scan input 825. Moreover, order and priority and completion of scanning can also be indicated as discussed above in the context of list based presentation of subtasks 505. It will now occur to those skilled in the art that there are other types of graphics and other manners of indicating subtasks 515, their order and priority, and completion on such graphics. These and other variations are within scope. In other variations, a task 405, a task iteration 705 or a subtask 505 may have additional metadata. Metadata can include signatures indicating who performed the actual process or operation. Metadata can also include information about shippers or receivers and other entities that will now occur to a person of skill in the art. In a further variation, metadata can be collected in a manner similar to performing an operation 510. In other variations, metadata can be provided by server 112 and confirmed through operations by client terminal 104. In yet a further variation metadata can be stored and communicated as part of the task or separately on its own.

It'll now occur to a person of skill in the art that tasks 400 can also be presented in a manner other than a list 400. For example, tasks 400 can be indicated on a graphic representing various locations at which processes associated with tasks 405 can be performed. Moreover, order and priority and completion of tasks 405 can also be indicated as discussed above in the context of list based presentation of tasks 405. Similarly, tasks iterations 705 can also be presented in a manner other than a list, for example using various graphic representations.

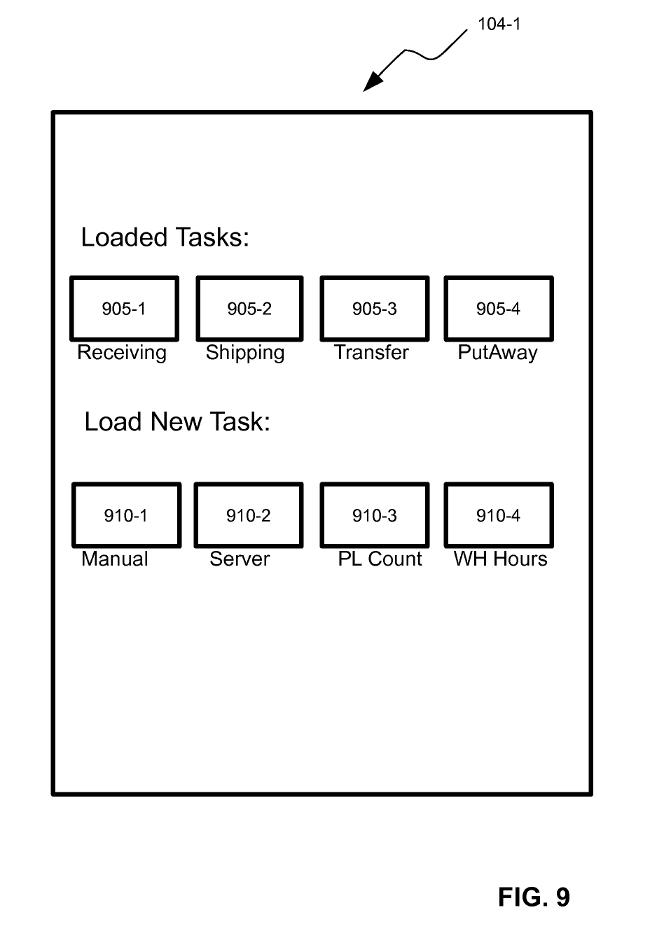

In a further variation, and as shown in FIG. 9, selectors 905 may be presented that provide access to tasks 405, each selector 905 reflecting a particular supply chain process. In the present example, specifically 905-1, 905-2, 905-3 and 905-4 are shown. Collectively, selectors 905-1, 905-2, 905-3 and 905-4 are referred to as selectors 905, and generically as selector 905. In this example embodiment, selecting selector 905-1 provides access to receiving operations related tasks 405, such as receiving supplies into a warehouse. Selecting selector 905-2 provides access to shipping operations related tasks 405, such as shipping supplies from a warehouse. Selecting selector 905-3 provides access to transfer operation related tasks 405 such as transferring supplies to a different location and selecting 905-4 provides access to put-away operations related tasks 405 such as organizing supplies within a warehouse area. It should now be apparent to a person of skill in the art that there are other supply chain operations and in other variations, Selectors 905 can provide access to each of those other operations. In other variations only selectors 905 that have pending, incomplete tasks may be shown providing a visual guide as to what type of operations are available for performing. In yet further variations, only selectors 905 which have tasks that can be performed on the basis of the determined location of client terminal 104 may be indicated. In alternative variations, the selectors 905 may all be shown but those which have actions or those which have performable actions based on location may be visually marked. These and other variations which will now be apparent to those skilled in the art are within scope.

Continuing with the example of FIG. 9, additional selectors 910 (selectors 910-1, 910-2, 910-3, 910-4) are also indicated. Collectively, selectors 910-1, 910-2, 910-3 and 910-4 are referred to as selectors 910, and generically as selector 910. This nomenclature is used elsewhere herein. In the present example, selectors 910 include selectors for accessing tasks from other sources such as through manual entry (selector 910-1) where the tasks are set up and performed manually, or through downloading from remote sources such as server 112 for example (selector 910-2). It should now be apparent to a person of skill in the art that there are various sources for obtaining tasks 405 and in other variations, Selectors 910 can provide access to each of those sources. For example, tasks could be loaded from other client terminals 104. In a variation, barcodes or other information can be scanned or otherwise inputted into client terminals 104. That information can then be used to requests tasks from a server or a specified location. Accordingly, as client terminal 104 enters an area, by scanning an RFID tag for example, is able to obtain tasks appropriate for that area. In yet other variations, the tasks 405 could be pushed to the client 104 in place of requiring client 104 to request the tasks 405 to be downloaded. In yet other variations, selectors 910 for only those sources that have new tasks that have not yet been downloaded may be indicated, or identified otherwise such as through various marks. These and other variations will now occur to those skilled in the art and are within scope.

Selectors 910 could also be used to access additional information related to supply chain operations. For example, as shown in FIG. 9, selectors for providing physical count or cycle count (910-3) and selectors for reporting working hours such as billable work for additional time taken to sort something or package it (910-4) can also be provided. In other variations, selectors for accessing output operations can also be included such as label printing for reproducing a label directly from a client terminal 104 into a bar code printer or laser printer.

Continuing with the example shown in FIG. 9, selecting one of selectors 905 can result in presenting a list of tasks that are available for that process. For example selecting selector 905-1 can result in the presentation of a list of tasks 405 that are associated with performing receiving processes. The lists can be ordered, prioritized and accordingly indicated as discussed above.

In a variation, augmented reality and object detection can be used to identify a number of aspects of performing a task or a subtask. For example, client terminal 104 can be used to present an images (video or still) of the present location taken with a camera integral or in communication with client terminal 104. Displayed images may be augmented by recognizing and or indicating the location of the items, directions to the location of the items in part based on location based services, the type of items (what an S-shirt, or a box containing it looks like, for example) the location of the information to be scanned on the boxes, and others which will now occur to a person of skill in the art. In other variations, displayed images can be augmented to indicate overall supply chain information such as the total number of S-shirts available in a warehouse or the location of particular recognized item within the supply chain itself.

In a variation, indication of tasks 405, subtasks 505, task iterations 705 and selectors are based on an account status of the client terminal 104. For example, if the logged-in account status indicates a supervisor or manager, different options will be presented than when the logged-in account status indicates an operator or a 3^{rd} party account is logged in.

The above-described embodiments are intended to be examples and alterations and modifications may be effected thereto, by those of skill in the art, without departing from the scope which is defined solely by the claims appended hereto. For example, methods and systems discussed can be varied and combined, in full or in part.

We claim:

1. A method of collecting supply chain information for an item on a handheld device comprising:
receiving a selection of a task, said task including subtasks linked by a workflow;
indicating a first set of subtasks to perform based on said workflow;
receiving an input indicating a performance of a selected subtask selected from said first set of subtasks; and
indicating a second set of subtasks to perform based on said workflow and said first performed subtask.

2. The method of claim 1 further including receiving said task from a server.

3. The method of claim 1 wherein said task includes a predetermined criteria and performance of said task is repeated until said predetermined criteria is met.

4. The method of claim 3 wherein said predetermined criteria is a number of items to be identified.

5. The method of claim 1 wherein said selected subtask includes one of a barcode scan, an RFID tag scan, an image capture, an audio capture, a video capture and a text entry.

6. The method of claim 1 wherein said input is determined to be invalid, the method further comprising:
providing an instruction on how to perform said selected subtask.

7. The method of claim 1 wherein said task is based on a supply chain process.

8. The method of claim 7 wherein said supply chain process is one of receiving, shipping, transfer or put-away.

9. The method of claim 1 further comprising: indicating a performance of said selected subtask with an input indicator.

10. The method of claim 9 wherein said selected subtask is a data scan operation and said input indicator is a text representation the scanned data.

11. The method of claim 1 further comprising:
presenting a graphical representation of a physical object containing at least a part of said supply chain information for said item; and
indicating, on said graphical representation, each of said first and second set of subtasks that are to be performed.

12. The method of claim 1 further including indicating a set of tasks, said presentation based on a logged-in account status indicator.

13. The method of claim 12 wherein said logged-in account status indicator includes one of operator, manager, and 3^{rd} party.

14. The method of claim 1 further including providing a map; indicating a location for each of said first and second set of subtasks.

15. The method of claim 1 wherein said indication of each subtask in said first and said second set of subtasks is in part based on a location of said handheld device.

16. The method of claim 1 further comprising:
providing an image of the area proximal to said handheld device;
indicating locations for said first and second set of subtasks on said image.

17. The method of claim 1 wherein performance of at least one of said subtasks indicated is mandatory.

18. The method of claim 1 wherein indication of said first and second subset of subtasks are arranged in order of priority.

19. A handheld device including a processor for collecting supply chain information for an item comprising:
at least one input device connected to said processor for receiving a selection of a task, said task including subtasks linked by a workflow;
an output device connected to said processor for indicating a first set of subtasks to perform based on said workflow;
said at least one input device further receiving an input indicating a performance of a selected subtask selected from said first set of subtasks; and
said output device further indicating a second set of subtasks to perform based on said workflow and said first performed subtask.

20. The handheld of claim 19 further comprising:
said at least one output device presenting a graphical representation of a physical object containing at least a part of said supply chain information for said item, said graphical representation including an indication of each of said first and second set of subtasks that are to be performed.
